(19) United States
(12) Patent Application Publication
(10) Pub. No.: US 2006/0024463 A1
(43) Pub. Date: Feb. 2, 2006

(54) Dry erase substrate

(75) Inventors: Frederick J. Gustafson, Bloomington, MN (US); John J. Emmel, Blaine, MN (US); Constance J. Nelson, Stillwater, MN (US); Ashish K. Khandpur, Lake Elmo, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/118,269

(22) Filed: Apr. 29, 2005

Related U.S. Application Data
(63) Continuation-in-part of application No. 10/899,907, filed on Jul. 27, 2004.

(51) Int. Cl. B32B 33/00

(52) U.S. Cl. 428/40.1

(57) ABSTRACT

A dry erase sheet is disclosed including a flexible substrate having a dry erase top surface and an opposing bottom surface. An adhesive is disposed on at least a portion of the bottom surface. A polymeric release layer is disposed on at least a portion of the dry erase top surface. A dry erase pad including a plurality of dry erase sheets and method of making dry erase sheets are also disclosed.

### CROSS-REFERENCE TO RELATED APPLICATION

This application is a continuation-in-part of application Ser. No. 10/899,907, filed Jul. 27, 2004, and is incorporated by reference herein.

### BACKGROUND

This invention relates to dry erase substrates. Specifically, the invention relates to a dry erase sheet having a release layer on the dry erase side and a repositionable or permanent adhesive on the opposite side.

It is commonly known in the art that surfaces are available that may be marked on with dry wipe markers, also known as dry erase markers or dry erasable markers. These markers use solvent based ink which dries to a frangible film after it has been applied to a surface, commonly a smooth, glossy, porcelain or plastic surface. These markers commonly come in different colors.

When a user writes on a dry erasable surface using conventional dry erasable markers, the ink readily adheres to the surface and may be applied in thick or thin strokes. The ink, after it dries, will adhere to the dry erasable surface for a long period of time, e.g., at least several months, without significantly flaking or otherwise peeling away from the dry erasable surface. The writing surfaces, often white in appearance, adapted for use with such markers are commonly known as “dry erase boards.”

The dry erasable marker ink, when applied, dries to a frangible film and may be readily wiped off from the dry erasable surface with a dry cloth or dry eraser. Solvent is not ordinarily needed in the erasing; hence these markers are known as “dry wipe,” “dry erase,” or “dry erasable.” One common family of dry erase markers is sold by the Sanford Corp., Bellwood, Ill. under the registered trademark, EXPO™.

Sheets and rolls that are temporarily correctable with dry erase markers are known. An example of a correctable sheet is Avery Cling Sheets (Avery-Dennison Corp., Pasadena Calif.). Cling sheets rely on static cling to adhere to walls and do not have an adhesive on the back side of the sheet. Dry erase sheets and rolls having an adhesive coating are also known. GoWrite adhesive sheets and rolls (InVision, Inc., Palatine, Ill.) are an example of adhesive coated dry erase sheets and rolls with release liner. The GoWrite products are coated with a repositionable adhesive. Another example of adhesive coated dry erase rolls is the New-Rite Vinyl Dry-Erase Surface Roll (Best-Write Manufacturing, Cameron, Tex.) which is coated with a permanent adhesive. These adhesive coated dry erase sheets come with a release liner covering the adhesive. The release liner is necessary because the adhesive on the back of the sheet does not release easily from the dry erase surface if a dry erase sheet is placed on top of another dry erase sheet. To use the product, the liner is removed and discarded.

The release liner is expensive to produce, expensive to laminate to the product, difficult to remove, and ultimately thrown away before the product is used. It is desirable to have an adhesive coated dry erase sheet without a release liner.

### SUMMARY

Generally, the present invention relates to a dry erase sheet having a release layer on the dry erase side and an adhesive on the opposite side. It is understood that a dry erase sheet can be made in roll form and optionally later unrolled to form a sheet or a smaller roll.

In one illustrative embodiment, a dry erase sheet is disclosed including a flexible substrate having a dry erase top surface and an opposing bottom surface. An adhesive is disposed on at least a portion of the bottom surface. A polymeric release layer is disposed on at least a portion of the dry erase top surface.

In another illustrative embodiment, a dry erase pad or roll includes a plurality of flexible substrates having a dry erase top surface and an opposing bottom surface. Each flexible substrate includes an adhesive disposed on at least a portion of the bottom surface and

a polymeric release layer disposed on at least a portion of the dry erase top surface. At least selected top surfaces are in contact with selected bottom surfaces.

In another illustrative embodiment, a method of making a dry erase substrate includes steps of providing a flexible substrate having a dry erase top surface and an opposing bottom surface, coating an adhesive on at least a portion of the bottom surface, and coating a polymeric release layer on at least a portion of the dry erase top surface to form a dry erase substrate.

The above summary of the present invention is not intended to describe each disclosed embodiment or every implementation of the present invention. The Figures, Detailed Description and Examples which follow more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a schematic cross-sectional view of an illustrative dry erase sheet;

FIG. 2 is a schematic cross-sectional view of an illustrative plurality of dry erase sheets forming a pad;

FIG. 3 is a schematic diagram of an illustrative process for making the dry erase sheet of FIG. 1;

FIG. 4 is a perspective front view of an illustrative dry erase sheet including a frame; and

FIG. 5 is a perspective rear view of the illustrative dry erase sheet including a frame of FIG. 4.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention. The Figures are not drawn to any particular scale and are simply presented for ease of illustration.

### DETAILED DESCRIPTION

The present invention is believed to be applicable generally to dry erase substrates and their manufacture. This invention also relates to a dry erase sheet having a release layer on the dry erase side and an adhesive on the opposite side. The invention may also include a pad or a roll of dry erase sheets with adhesive on the back of each sheet that can be stacked in a pad or roll form without a release liner and easily separated for use. Separation of adhesive coated sheets without a release liner is accomplished with a release layer on top of the sheet. The release layer provides a dry erase surface to which adhesives can be attached and removed. In some embodiments, the present invention is an improvement in adhesive coated dry erase sheets allowing the sheets to be stacked up top of each other without a release liner, and be easily removed at a later time.

The invention can also provide a dry erase sheet that is markable with dry erase markers, erasable and has low release to adhesives. One useful property of the dry erase surface is wettability of the surface by dry erase markers. Wettability refers to a writing line that can retain its shape as the solvent dries. Dewetting of the solvent causes the line to move in or break at certain points, causing voids in the writing. Dewetting of markers can be observed, for example, when writing on some silicone release liners. Solvent compositions of dry markers are listed on the marker or reported on the MSDS for the marker. Common solvents for dry erase markers include, for example, ethanol, isopropanol, methyl isobutyl ketone and n-butyl acetate. One solvent with a high surface tension is n-butyl acetate, having a surface tension of about 25 mJ/m². Therefore, in some embodiments, a dry ease surface can be wettable by solvents with a surface tension of about 25 mJ/m² or less.

Another useful property of the dry erase surface is erasability. Illustrative components of erasability are solvent penetration and marker adhesion build. The release layer should be thin enough so that the marker ink does not penetrate through it and become hidden to the eraser. Neither should the dry ink become more attached to the surface over time resulting in difficult erasing.

A third useful property on the dry erase surface is release to adhesives. Many adhesives stick strongly to dry erase surfaces. That is why known dry erase adhesive sheets typically include a release liner. Polymeric release layers (such as coatings, for example) are known that reduce the adhesion of adhesives to the backside of adhesive coated products, for example, tapes. These release polymers typically rely on low surface energy to deliver the release property. A partial listing of low surface energy functional groups on polymers includes silicones, fluorocarbons, and long chain, crystalline hydrocarbons.

It is desirable in many embodiments to coat a polymeric release layer on a dry erase surface and achieve wet out of dry erase markers, erasability of the markers, and provide release of the dry erase surface to adhesives. While the present invention is not so limited, an appreciation of various aspects of the invention will be gained through a discussion of the examples provided below.

For the following defined terms, these definitions shall be applied, unless a different definition is given in the claims or elsewhere in this specification.

The term “polymer” will be understood to include polymers, copolymers (e.g., polymers formed using two or more different monomers), oligomers and combinations thereof, as well as polymers, oligomers, or copolymers that can be formed in a miscible blend by, for example, coextrusion or reaction, including transesterification. Both block and random copolymers are included, unless indicated otherwise.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings of the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

Weight percent, percent by weight, % by weight, and the like are synonyms that refer to the concentration of a substance as the weight of that substance divided by the weight of the composition and multiplied by 100.

The recitation of numerical ranges by endpoints includes all numbers subsumed within that range (e.g. 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. Thus, for example, reference to a composition containing “an adhesive” includes a mixture of two or more adhesives. As used in this specification and the appended claims, the term “or” is generally employed in its sense including “and/or” unless the content clearly dictates otherwise.

The terms “dry erase surface, dry erase substrate, and dry erase sheet” include materials that are markable with dry erase markers and erasable with a dry eraser for time periods ranging from minutes to weeks, for example. Substrates that can be erased only in the short term, ie, minutes or hours, are also called correctable substrates.

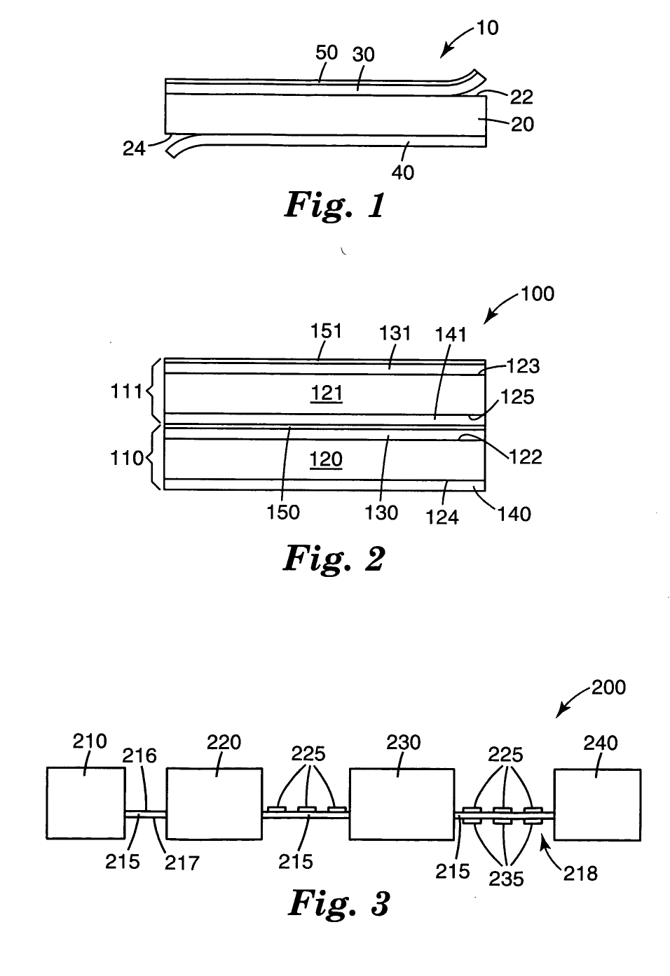

One embodiment of the invention provides a linerless adhesive coated dry erase sheet with dry erase properties. That is, dry erase markers are removable from the sheet after a certain time, that time ranging from minutes to weeks. FIG. 1 is a schematic cross-sectional view of an illustrative dry erase sheet 10. The dry erase sheet 10 includes a substrate 20 having a top side or top surface 22 and an opposing bottom side or bottom surface 24. An adhesive layer 40 can be disposed on or adjacent to, at least a portion of, the bottom surface 24. As used herein, the term “adjacent to” refers to, being in close proximity to, and can include one or more interposing layers. A polymeric release layer 50 can be disposed on or adjacent to, at least a portion of, the dry erase top surface 22. In some embodiments, the substrate 20 has dry erase properties, thus the polymeric release layer 50 can be in contact with the substrate top surface 22. In other embodiments (see FIG. 1), a dry erase layer 30 can be disposed between the substrate top surface 22 and the polymeric release layer 50, thus the polymeric release layer 50 can be in contact with the dry erase layer 30.

In one illustrative embodiment, the dry erase sheet 10 is a film or paper that is coated with a radiation curable resin to impart dry erase properties on the sheet. In another illustrative embodiment, the dry erase sheet 10 is a film or paper sheet coated with a layer that is not radiation curable. In still another illustrative embodiment, the dry erase sheet 10 is a smooth, uncoated film sheet.

The adhesive 40 can be repositionable or permanent. It can be coated fully across the back or bottom side 24 of the substrate 20 or it can be coated in one or more stripes on the substrate 20. In some embodiments, the substrate 20 can have a square or rectangular shape and have an adhesive stripe along two opposing sides of the substrate 20. A rectangular shaped substrate can have two adhesive stripes along either opposing long sides of the rectangle or opposing short sides of the rectangle, as desired.

In some embodiments, the coating pattern of the release layer (or coating) 50 can match the coating pattern of the adhesive 40. That is, if the adhesive is fully coated across the sheet, the release layer can also be fully coated across the sheet. The release layer can be coated fully across the sheet or it can be coated in one or more stripes on the sheet. The release layer can be stripe coated to match the location of the adhesive stripes on the substrate. When the dry erase sheets, dual coated, are stacked on top of each other, the release coating can enable the adhesive sheets to be removed one from the other without the use of a release liner.

The polymeric release layer can also allow the adhesive dry erase sheets to be made in roll form. The roll can be perforated or fully slit to allow individual substrate sheets to be removed as the roll is unrolled by a user. A plurality of perforation lines can be formed along a width (transverse direction or TD) of a continuous length (machine direction or MD) of dry erase substrate. In some embodiments, an adhesive stripe and a release layer can be disposed along the TD of the dry erase substrate. In other embodiments, the adhesive stripe and a release layer can be disposed along the MD of the dry erase substrate.

In some embodiments, individual substrates can then be rolled into a roll form. These individual dry erase sheets can abut one another or at least partially overlap an adjacent dry erase sheet. In either case, the adhesive layer contacts the release layer of an adjacent or overlapping dry erase sheet to allow the dry erase sheets to be removed from the roll for use. In some embodiments, the adhesive layer can be stripe coated along each outside edge of the roll or the adhesive layer can be stripe coated along a width of each dry erase sheet.

One illustrative embodiment includes a pad of dry erase sheets with repositionable adhesive on the back of each sheet that can be stacked in a pad without a release liner and easily separated for use. FIG. 2 is a schematic cross-sectional view of an illustrative plurality of dry erase sheets forming a pad 100. A first dry erase sheet 110 includes a substrate 120 having a top side or top surface 122 and a bottom side or bottom surface 124. An adhesive layer 140 can be disposed on or adjacent to at least a portion of the bottom surface 124. A polymeric release layer 150 can be disposed on or adjacent to at least a portion of the dry erase top surface. In some embodiments, the substrate 120 has dry erase properties, thus the polymeric release layer 150 can be in contact with the substrate top surface 122. In other embodiments (see FIG. 2), a dry erase layer 130 can be disposed between the substrate top surface 122 and the polymeric release layer 150, thus the polymeric release layer 150 can be in contact with the dry erase layer 130.

A second dry erase sheet 111 can be disposed on the first dry erase sheet 110. The second dry erase sheet 111 includes a substrate 121 having a top side or top surface 123 and a bottom side or bottom surface 125. An adhesive layer 141 can be disposed on or adjacent to at least a portion of the bottom surface 125. A polymeric release layer 151 can be disposed on or adjacent to at least a portion of the dry erase top surface. In some embodiments, the substrate 121 has dry erase properties, thus the polymeric release layer 151 can be in contact with the substrate top surface 123. In other embodiments (see FIG. 2), a dry erase layer 131 can be disposed between the substrate top surface 123 and the polymeric release layer 151, thus the polymeric release layer 151 can be in contact with the dry erase layer 131.

The second dry erase sheet 111 adhesive layer 141 can be in contact with the first dry erase sheet 110. The second dry erase sheet 111 adhesive layer 141 can be in contact with the first dry erase sheet 110 polymeric release layer 150. Separation of adhesive coated sheets without a release liner can be accomplished with the polymeric release coating on the dry erase surface.

Another aspect of the present invention provides a method of making a continuous roll or pads of adhesive coated dry erase sheets without using a release liner in the manufacturing process. FIG. 3 is a schematic diagram of an illustrative process 200 for making a dry erase sheet or roll described above. The method 200 includes steps of providing a flexible substrate 215 having a dry erase top surface 216 and an opposing bottom surface 217. The flexible substrate 215 can be provided in roll or sheet form by a feed source 210.

The flexible substrate 215 is coated with a polymeric release layer 225 on at least a portion of the top surface 216 by a release layer coater 220. The release layer coater 220 can apply a polymeric release layer 225 to the entire top surface 216 (not shown) or the release layer coater 220 can apply the layer 225 as stripes of release coating 225 (shown).

The flexible substrate 215 may then be coated with an adhesive 235 on at least a portion of the bottom surface 217 by an adhesive coater 230 to form a coated flexible substrate 218. The adhesive coater 230 can apply adhesive 235 to the entire bottom surface 217 (not shown) or the adhesive coater 230 can apply adhesive 235 as stripes of adhesive 235 (shown). In some embodiments, the stripe of adhesive 235 is in vertical registration with the stripe of polymeric release layer 225 on the coated flexible substrate 218.

The coated flexible substrate 218 can then proceed to further processing 240. Further processing can include rolling the coated flexible substrate 218 into a roll such that the adhesive 235 on one roll turn contacts the polymeric release layer 225 on an adjacent roll turn. The dry erase substrate with adhesive on the back can be wound up on itself in a large roll. Because the release coating provides release of the adhesive from the dry erase substrate, the roll can be easily unwound at a later time and converted into sheets, pads, or rolls.

Further processing can also include the step of cutting the flexible coated substrate 218 into a plurality of sheets and forming a pad of sheets such that the adhesive layer 235 of at least selected sheets contact the polymeric release layer 225 of selected sheets. The flexible coated substrate 218 can be cut into separate sheets immediately following the formation of the coated flexible substrate 218 or can occur after un-rolling or un-winding a roll of pre-rolled coated flexible substrate.

In some embodiments, the polymeric release coating on the dry erase surface is writable with dry erase markers and is erasable with a dry eraser. While the release layer does not necessarily impart dry erase properties to a substrate, neither does it significantly degrade the dry erase properties of said substrate. In one embodiment, the invention also provides a dry erasable pad wherein release coated dry erasable sheets are able to be coated on the back of the sheet with a repositionable adhesive and stacked in a pad without a release liner covering the adhesive.

In another embodiment, the invention includes a pad of dry erase or correctable paper sheets with repositionable adhesive on the back of each sheet that can be stacked in a pad and easily separated for use. On the first side of the film or paper substrate there is a UV curable topcoat that provides a dry erase surface. On top of the UV curable topcoat is a writable release coating. On the second side of the substrate there is a repositionable adhesive coated in a stripe. The dry erase sheets are then stacked on top of each other to form a pad. The release coating can have unique and unexpected properties of reducing the adhesion level of the adhesive to the dry erase surface while at the same time preserving the writing and erasing properties of the dry erase surface.

Suitable substrates for the inventive dry erase article are sheets and films of polymeric resins, including both thermoplastic and thermoset resins. Example polymeric resins are polyesters, polyethers, polyamides, polyurethanes, polyacrylates, polyethylene, polypropylene, polyvinyls, cellulose esters, epoxy resins, phenolic resins, polysiloxanes, polystyrene, copolymers of acrylonitrile-styrene, butyrates, tetrafluoroethylene, ethylene-tetrafluoroethylene, and the like. Other suitable substrates are paper based, for example, coated paper, polymer coated paper, and paper film laminates. Metal films and sheets are also suitable substrates. In one illustrative embodiment, the substrate is chosen so as to have a flexibility of at least about 6.4 mm as measured by the Mandrel Bend Test allowing the substrate to be used in a continuous (or web type) manufacturing process, and/or allowing it to be transported and stored in roll form. In some embodiments, substrates have a thickness in a range of 25 to 500 microns, or 50 to 250 microns, or 75 to 175 microns.

Although not necessary in all embodiments due to the adherence of coating compositions used in the current invention, separate primer layer(s) comprising a single ingredient or mixture of ingredients, may be present on the surface of the substrate in order to bond to an eventual coating. Example primers include polyacrylates, melamine acrylates, poly vinyl chlorides, poly vinylidene chlorides, and polyvinyl alcohols. Texturizing, chemical, or physical treatment of the surface may also be used to improve bonding, for example, flame or corona treatment.

In one embodiment of the invention, a smooth, non-porous film is used without additional coatings as a correctable dry erase surface. Dry erase markers are fully or partially removable from the surface using a dry eraser for minutes or hours. However, over time the dry erase writing becomes more difficult to remove from the substrate.

In another embodiment of the invention, the substrate is coated with a resin that makes possible or improves the degree of dry erase marker removal over time. Suitable resins include those that are radiation curable and those that are not radiation curable.

Resins that are not radiation curable can improve the short term correctability of dry erase markers on a substrate. Examples of such resins that are not radiation curable include cellulose esters, alkyd resins, and butylated urea-formaldehyde resins. The example resins may be coated individually or together on the sheet. These resins are particularly useful when coated on a precoated paper. Coated papers provide a smooth surface with good hold out of further coatings. The example resins when coated on precoated paper can form a barrier to the penetration of dry erase marker solvents into the sheet. Since the dry erase binder and dyes are on the surface of the paper and the binder is frangible, the sheet has a degree of short term erasability.

Radiation curable coating compositions that may be suitable for use with the current inventive dry erase article are disclosed in U.S. Pat. No. 4,885,332, U.S. Pat. No. 5,104,929, U.S. Pat. No. 6,458,462 and U.S. Pat. No. 6,265,061, all of which are incorporated by reference in their entirety herein. Commercially available UV curable resins include Gafgard 300 (ISP Technologies, Wayne, N.J.) and Rad-Kote 860DEF (Rad-Cure Corporation, Fairfield, N.J.). In some embodiments, a radiation curable coating can have a cured thickness in a range of 1 to 30 micrometers, or 1 to 20 micrometers, or 2 to 10 micrometers.

In one illustrative embodiment, the radiation curable coating solution includes an organic matrix and colloidal inorganic oxide particles. The organic matrix can include a variety of monomers, oligomers, and/or polymers that form the cured matrix for the inorganic oxide particles. The organic matrix can include at least one ethylenically unsaturated monomer. The organic matrix can contain at least one organofunctional silane monomer coupling agent. The curable composition may also include further optional initiators, photosensitizers and additives, as desired.

The adhesive on the back side of the substrate can be used to attach the dry erase sheet to vertical surfaces. The adhesive can be a permanent, removable, repositionable, or a temporarily repositionable adhesive, as desired. In one illustrative embodiment, the adhesive is a repositionable microsphere adhesive of the type described by 3M in U.S. Pat. No. 3,691,140, U.S. Pat. No. 5,571,617, U.S. Pat. No. 5,824,748, U.S. Pat. No. 5,045,569, and WO 94/19420. The adhesive may be a microsphere adhesive with surface functional groups. The adhesive may be a composite microsphere adhesive. The adhesive may be a hollow microsphere. Alternatively, the adhesive may be a mixture of a microsphere adhesive and a permanent adhesive acting as a binder. The adhesive may be fully coated on the back side of the substrate or it may be coated in one or more stripes (i.e., stripe coating.) In some embodiments, the adhesive layer has a coating weight in a range of 0.1 to 5 grams/ft².

A polymeric release layer can be applied to the dry erase surface. The polymeric release layer can be writable and erasable with dry erase markers. In at least some embodiments, useful polymeric release layers provide a low release value, a reduced peel adhesion value, and a specified surface energy.

Polymeric release layer (or for example, coating) can posses a low adhesive release value. In some embodiments, the polymeric release layer can have an permanent adhesive release value from 10 to 200 g/in, or 10 to 100 g/in, or 10 to 40 g/in, or in a range of 100 g/in or less, or in a range of 50 g/in or less, as measured by the Release Test described in the Test Methods section below.

Polymeric release layer can posses a reduced peel adhesion value. In some embodiments, the polymeric release layer can reduce the peel adhesion value of the top surface by 10 to 99%, or 30 to 90%, or by 25% or greater.

Polymeric release layer can be wettable with solvents of a specified surface tension value. In some embodiments, the polymeric release layer can be wettable by solvents with a surface tension equal to or less than 25 mJ/m². One illustrative polymeric release coating is described in U.S. Pat. No. 4,728,571, which is incorporated by reference herein. This release coating includes a copolymer having a vinyl polymeric backbone with a T_{g} or Tₘ above −20° C. and having grafted to the backbone a monovalent siloxane of number average molecular weight above about 1,000.

Another illustrative polymeric release coating is described in U.S. Pat. No. 3,011,988 which is incorporated by reference herein. This polymer is the copolymerization product, in percent by weight of: (1) from 25 to 65% of an ester of a long chain alkyl terminated primary alcohol wherein the terminal alkyl chain is from at least 12 to 22 carbon atoms in length, and an acid selected from the group consisting of acrylic and methacrylic acids; (2) 3 to 15% of an acrylic acid selected from the group consisting of acrylic and methacrylic acids; (3), 10 to 35% of a nitrile of an acid selected from the group consisting of acrylic and methacrylic acids; and (4) from 10 to 40% of a compound selected from the group consisting of methyl, ethyl and cyclohexyl acrylate.

Another illustrative polymeric release layer may be described as a polymer of A, B and C monomers that form a polymeric backbone, with an optional D monomer grafted thereto, where:

A is at least one free radically polymerizable vinyl monomer with a terminal hydrocarbon group of less than 12 carbons;

B is at least one polar monomer copolymerizable with A; and

C is an ester of a long chain alkyl terminated primary alcohol where the terminal alkyl chain is from at least 12 to about 22 carbon atoms in length, and an acid selected from the group consisting of acrylic and methacrylic acids, and

D is a monomer having the general formula X—(Y)ₙSiR₃₋ₘZₘ where:
X is a vinyl group copolymerizable with the A and B monomers,
Y is a divalent linking group where n is zero or 1,
m is an integer of from 1 to 3;
R is hydrogen, (C₁-C₄)alkyl (e.g., methyl ethyl, or propyl), aryl (e.g., phenyl or substituted phenyl), or (C₁-C₄)alkoxy; and
Z is a monovalent siloxane polymeric moiety having a number average molecular weight above about 1,000 and being essentially unreactive under copolymerization conditions.
   The amount and composition of C and D monomers being such as to provide the release layer with a release value not greater than about 100 g/in to permanent adhesives.

Proper selection of the monomers of the polymeric backbone makes it possible to obtain a layer that not only presents a stable low energy release surface when in prolonged contact with an adhesive but also presents a wettable surface when in contact with dry erase marker ink. While not wishing to be bound by any particular theory, it is believed that, in at least some embodiments, wet out of dry erase markers is at least partially dependent on the polymeric backbone composed of monomers with homopolymer surface energies greater than 25 mJ/m². Such a copolymer backbone can be wettable by a range of solvents including, for example, ethanol, isopropanol, methylethyl ketone, and n-butyl acetate. It is also believed that release from adhesives is accomplished by copolymerizing or grafting onto this polymer backbone, monomers having functional groups with surface energies of less than 25 mJ/m². Low surface energy functional groups include silicones, fluorocarbons, and terminal alkyl groups, especially crystalline terminal alkyl groups. It is believed that solvents can penetrate through the pendant low surface energy groups and wet out the polymer backbone, while adhesives only come in contact with the low surface energy pendant groups.

In some embodiments, the non-polar A monomer or monomers (there may be more than one) are chosen such that a backbone T_{g} or Tₘ is above −20° C. to provide a tack-free material upon polymerization of A (or A and B). Representative examples of A monomers include styrene, vinyl acetate, vinyl chloride, vinylidene chloride, acrylonitrile, and acrylic or methacrylic acid esters of non-tertiary alcohols such as methanol, ethanol, propanol, isopropanol, butanol, isobutanol, cyclohexanol, benzyl alcohol, and dodecanol, the alcohols having from 1 to 12 carbon atoms. Such monomers are known and are commercially available. In some embodiments, the A monomer is methyl acrylate. The amount of A monomer in the release coating can be between 10% and 50%.

In some embodiments the A monomer can be a non-polar monomer and the B monomer can be a polar monomer. Representative examples of polar B monomers which may be used either individually or in combination include acrylic acid, methacrylic acid, itaconic acid, acrylamide, acrylonitrile, methacrylamide, N,N-dimethylacrylamide, N-vinyl pyrollidone, methacrylonitrile, and maleic anhydride. Monomers having a hydroxyl functionality, e.g., 2-hydroxyethyl acrylate, 2-hydroxyethyl methacrylate, hydroxypropyl acrylate, and dihydroxypropyl acrylate, may also be used. In some embodiments, acrylic acid, methacrylic acid, acrylamide, acrylonitrile, and N-vinyl pyrollidone are useful. In some embodiments, the amount by weight of B monomer does not exceed 45% of the total weight of all monomers. In other embodiments, incorporation of B monomer to the extent of 10 to 40% by weight can provide the backbone copolymer compatibility with ethanol and isopropanol. The B monomer may also enhance adhesion of the copolymer to a substrate.

C can be an ester of a long chain alkyl terminated primary alcohol where the terminal alkyl chain is from at least 12 to 22 carbon atoms in length, and an acid selected from the group consisting of acrylic and methacrylic acids. Representative examples of the C monomer are the acrylic and methacrylic esters of dodecanol, tetradecanol, hexadecanol, octadecanol, the C₂₀ primary alcohol, and the C₂₂ primary alcohol. Polymers containing such esters are known in the art to have crystalline side chains that provide release when in contact with adhesives. The C monomer may be present in a concentration of 0 to 60%.

The optional D monomer can be grafted to the backbone of the copolymer of A, B, and C monomers. The D monomer, a silicone macromer, is described in U.S. Pat. No. 4,728,571. The D monomer can have the general formula X—(Y)ₙSiR₃₋ₘZₘ described above and may be further defined as having an X group which can have the general formula: 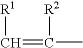
where R¹ is a hydrogen atom or a COOH group and R² is a hydrogen atom, a methyl group, or a CH₂COOH group.

The Z group of the D monomer can have the general formula: 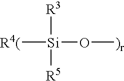
where R³ and R⁵ are independently lower alkyl, aryl, or fluoroalkyl, where lower alkyl and fluoroalkyl both refer to alkyl groups having from one to four carbon atoms and where aryl refers to phenyl or substituted phenyl. R⁴ may be alkyl, alkoxy, alkylamino, aryl, hydroxyl, or fluoroalkyl, and r is an integer from about 5 to 700. In some embodiments, the D monomer has a general formula selected from the group consisting of the following, where m is 1, 2, or 3, p is zero or 1, R″ may be alkyl or hydrogen, and X, R, and Z are as defined above: 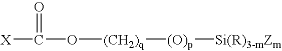
wherein q is an integer from 2 to 6; 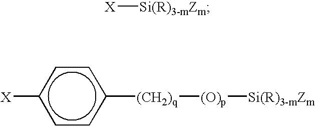
wherein q is an integer from zero to 2; 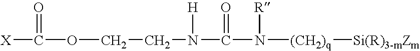
wherein q is an integer from 2 to 6; 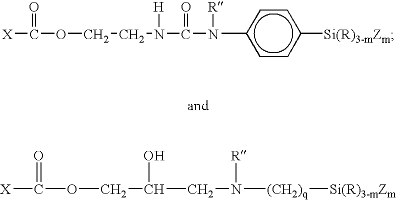
   where q is an integer from 2 to 6.

When the above-described A, B, C, and D monomers are copolymerized and coated on a backing, a polymeric release surface is obtained. The level of release is related, at least in part, to both the molecular weight of D and its weight percentage in the copolymer. Copolymers containing D monomer having a molecular weight less than 1,000 are not as effective as a release coating containing D monomer having a molecular weight of 1,000 or greater. Copolymers containing D monomer having a molecular weight greater than 50,000 provide effective release coatings, but little increase in performance is noted by increasing the molecular weight beyond 50,000. Also, at very high molecular weights of D, e.g., in excess of 50,000, possible incompatibility of the D monomer with the remaining monomer during the copolymerization process may result in reduced incorporation of D monomer. In some embodiments, D monomer molecular weight can range from 1,000 to 50,000. In other embodiments, D molecular weight ranges from 5,000 to about 25,000.

The amounts of C and D monomer in the polymeric release layer may be selected to achieve the desired level of release from a specific adhesive. For example, if the adhesive is a permanent adhesive, it may be desirable to use higher amounts of C and D monomer in the release layer. If the adhesive is a repositionable adhesive, it may be desirable to use lower amounts of C and D monomer in the release layer.

The amounts of C and D monomer in the polymeric release layer may be also be selected to achieve the desired level of wet out of dry erase markers. Silicone polymers alone are known to cause dewetting of dry erase markers. If a specific polymeric release layer causes dewetting of some dry erase markers, if may be desirable to use lower amount of D monomer in the release layer, as desired.

It is not necessary to have both C and D monomer in the polymeric release layer. Release to adhesives can be provided by the C or the D monomer alone. The D monomer can be incorporated in the copolymer in the amount of about 0 to 35% of the total monomer weight to obtain the desired release value. Higher amounts of D monomer in the polymeric release layer may cause dewetting of dry erase markers. The amount of D monomer included may vary depending upon the particular application and adhesive. Incorporation of such percentages of D monomer having a molecular weight in the above-specified range has been found to proceed smoothly and to result in material which provides effective release for a variety of adhesives while still being cost effective.

Release to adhesive can also be provided by the C monomer alone. In some embodiments, if the amount of C monomer in the polymeric release coating is zero, then the amount of D monomer may be up to 35%. In other embodiments, if the amount of D monomer is zero, then the amount of C monomer can be up to 55%. In still other embodiments, if the C and D monomers are both present, the total amount of C monomer and D monomer does not exceed 55%, and the amount of D monomer does not exceed 35%.

In addition, block polymers of polydimethylsiloxane and vinyl monomers, such as those prepared according to methods described in U.S. Pat. No. 4,584,356, can also be utilized as an polymeric release layer, providing that the monomers that make up the vinyl endblocks are chosen to meet the requirements described above for the grafted structures.

To provide the necessary release values to adhesives, the polymeric release compositions may include either the defined copolymer alone or such a copolymer blended with compatible homopolymer, copolymer, etc., providing that these blends meet one or more of the requirements described above. These polymeric release compositions may not require curing or crosslinking; however, if solvent resistance is desired for a particular application, crosslinking can be effected by standard methods well-known in the art, such as radiation curing (electron beam or ultraviolet light) or chemical crosslinking. The presence of a low level of crosslinking to impart solvent resistance may not significantly affect the ink-receptivity.

Optional fillers or pigments (e.g., alumina, silica, titania, or calcium carbonate) may be added to the copolymer compositions.

The polymeric release coating can be made in solvent or water. It can be coated out of solvent or water. The polymeric release coating can be coated onto a substrate by coating methods known in the art such as gravure coating, die coating, roll coating, rod coating, or flexo printing. The polymeric release coating can be coated in one or more stripes or it can be pattern coated by methods known in the art.

In some embodiments, the polymeric release layer has a dry thickness in a range of 0.01 to 5 micrometers, or 0.1 to 5 micrometers, or 0.2 to 2 micrometers, or 0.01 to 2 micrometers, or 0.1 to 1 micrometers. The dry coating thickness of the polymeric release layer can, at least in part, affect the release value of the coating to adhesives. In general, a thicker release coating has a lower release value. Coating on a rough or porous substrate tends to increase the release value to adhesives. In one embodiment of the invention, the dry coating thickness of the polymeric release layer is optimized for release to an adhesive and for wet out of dry erase markers. Dry coating thickness can be optimized by changing the coating weight or the percent solids of the release coating formulation.

In some embodiments, the dry erase sheet or roll can include a frame element on one, two, three, or four sides of the sheet or roll. The frame element itself can have release properties to adhesives. For example, the frame element can be a strip of tape coated with a release coating. In another embodiment, the frame element can have a rough surface providing mechanical release to adhesives. In another embodiment, the frame element can be offset from an adhesive stripe behind it. In another embodiment, the frame element can be narrow compared to the width of the adhesive stripe, such a narrow frame having some release from an adhesive. The frame element can improve the appearance of the sheet. The frame element can also prevent writing and erasure over the side of the sheet when in use.

FIG. 4 is a perspective view of an illustrative dry erase sheet including a frame 300. The dry erase sheet or pad includes a dry erase writing surface 312 and a peripheral edge 315 bounding the writing surface 312. One or more frame elements 314 can be disposed proximate to the peripheral edge 315. In one embodiment, one frame element 314 is disposed proximate to the peripheral edge 315. In another embodiment, two frame elements 314 are disposed proximate to the peripheral edge 315. In another embodiment, three frame elements 314 are disposed proximate to the peripheral edge 315. In still another embodiment, four frame elements 314 are disposed proximate to-the peripheral edge 315.

Framing element or strip 314 may consist of several different types of materials being adhesively attached to the writing surface 312 around peripheral edge 315. Framing element 314 may be formed from a variety of materials. By way of non-limiting example, framing element 314 can be formed from plastic materials such as but not limited to vinyl, polyolefins, polystyrene, polyester, and polyurethane. These plastic materials may be in the form of plastic adhesive backed tapes of varying thicknesses that are secured to writing surface 312 by applying the adhesive side of the tape against writing surface 312. Foam materials such as but not limited to polyethylene, vinyl, polyurethane, rubber, polyether and silicone open and closed cell foams may also be used to form framing strip 314. Examples of these types of foams are available in an adhesive backed tape form from 3M Company of St. Paul, Minn. (4516 Single Coated Vinyl Foam Tape, 4314 Single Coated Urethane Tape) and Kent Manufacturing Company of Grand Rapids, Mich. Non-woven materials can also be used to form framing element 314. Exemplary non-woven materials include but are not limited to Dupont™ Tyvec™ spunbonded olefin materials available from E. I. du Pont de Nemours and Company, Wilmington, Del. and Micropore™ medical tape from 3M Company of St. Paul, Minn. Additionally, other materials such as cork, felt fabric, woven fabrics, and plastic coated fabrics may be used.

Framing element 314 material can be adhesively bonded to writing surface 312. Suitable adhesives for bonding the framing element 314 to the writing surface 312 are pressure sensitive or hot melt adhesives. Framing element 314 can be secured to writing surface 312 such as by thermal lamination, ultrasonic lamination, microwave lamination, or by application using a permanent adhesive (e.g., a pressure sensitive adhesive or a hot melt adhesive) or adhesive film such as Scotch™ Hi Strength Adhesive, Scotch™ 300LSE Hi Strength Adhesive, or 3M™ Command™ Adhesive (all available from 3M Company, St. Paul, Minn.), among other methods known to one skilled in the art.

Alternatively, framing element 314 could be printed directly onto the writing surface 312. The printed framing strip would give the user a visual cue that the user is approaching the edge of the sheet with the marker or eraser. The printing inks could consist of solvent based, water based or monomer based UV curable inks commonly used for screen printing, flexographic printing or offset printing. Any one of these printing methods could be used for applying a printed type framing element 314. The printing ink could also include an expanding agent such as but not limited to EXPANCEL® spherical plastic microspheres available from Akzo Nobel Company, The Netherlands. This expanding agent will raise the ink to a greater thickness (i.e. such as if an embossing technique had been used). In addition to a visual cue the raised ink also gives the user a tactile cue (as described previously) to help prevent the user from writing past the peripheral edge of the sheet onto the supporting surface which can damage or lessen the aesthetic quality of the underlying surface. Framing element 314 can define a step between writing surface 312 and outer surface of framing element 314. This step can help to prevent a user from “overwriting” or writing past the peripheral edge 315 of writing surface 312.

Further Discussion

In some embodiments, mechanical fasteners can be attached to the dry erase sheets described herein. In many embodiments, these mechanical fasteners can be attached to the top two or all four corners of the dry erase sheet to secure the sheet firmly to a woven surface such as, for example a fabric wall. In some embodiments, the mechanical fastener element has adhesive on a back side of the mechanical fastener for secure mounting to a rear side of the dry erase sheet.

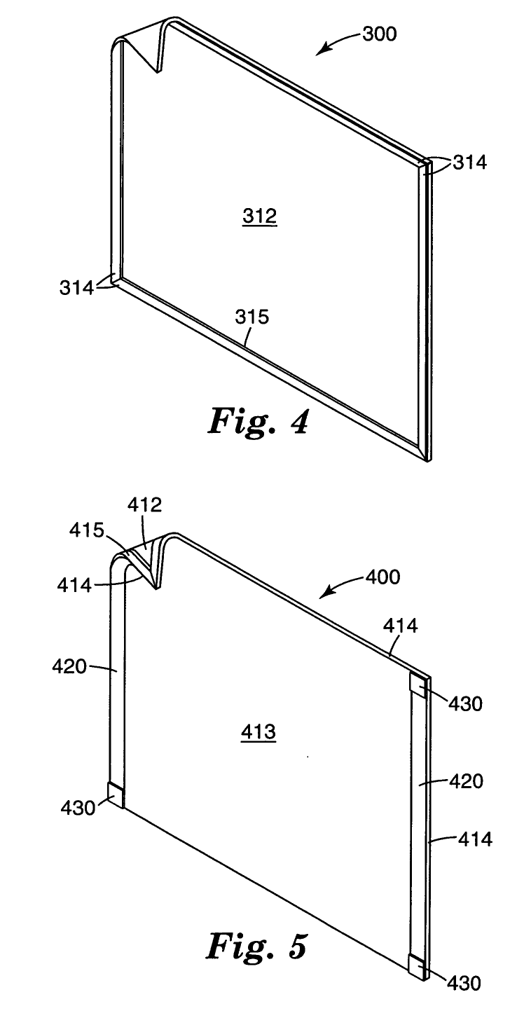

FIG. 5 is a perspective rear view of the illustrative dry erase sheet 400 including a frame of FIG. 4. The dry erase sheet 400 includes a dry erase writing surface 412 and a peripheral edge 415 bounding the writing surface 412. One or more frame elements 414 can be disposed proximate to the peripheral edge 415, as described above. The dry erase sheet 400 includes a rear or back-side surface 413. In many embodiments, one or more adhesive stripes 420 (described above) are disposed on the rear surface 413. In some embodiments, adhesive strips 420 are disposed along opposing sides of the dry erase sheet 400, as shown.

In some embodiments, one or more mechanical fasteners 430 are attached to the rear surface of the dry erase sheet 400. In the illustrated embodiment, four mechanical fasteners 430 are attached to the dry erase sheet 400 at or near each corner of the dry erase sheet 400. In other embodiments, a plurality of mechanical fasteners 430 are disposed along one or more peripheral edge 415 of the rear surface 413. In some embodiments, the mechanical fasteners 430 have a rectangle or square shape and have a dimension in a range from 2.5 cm by 1.0 cm to 20 cm by 20 cm.

The mechanical fastener can be any mechanical fastener. In many embodiments, the mechanical fastener is selected from a large number of male fastener shapes have been described. For example, a first category of male fastener materials are designed to engage with the fibers of knitted, woven, or nonwoven fabrics. These male fasteners include cut loop hooks like those described in U.S. Pat. No. 2,717,437 (De Mestral), U.S. Pat. No. 2,820,277 (Forster), and U.S. Pat. No. 3,009,235 (De Mestral) and sold by Velcro USA Inc. (Manchester, N.H.) under the trade name Velcro® and by 3M Company (St. Paul, Minn.) under the trade name Scotchmate®; molded “J hooks” like those described in U.S. Pat. No. 3,758,657 (Menzin, et al.), U.S. Pat. No. 4,775,310 (Fischer), U.S. Pat. No. 5,131,119 (Murasaki), and U.S. Pat. No. 5,800,760 (Akeno) and sold by Velcro USA Inc., (Manchester, N.H.) under the brand name Ultramate™; molded “palm tree” hooks like those described in U.S. Pat. No. 5,537,720 (Takizawa) and U.S. Patent Application No. 2004/0091849 (Gallant, et al.); molded “mushroom” and disc-shaped hooks like those described in U.S. Pat. No. 3,192,589 (Pearson), U.S. Pat. No. 3,270,408 (Nealis), U.S. Pat. No. 5,077,870 (Melbye, et al.), U.S. Pat. No. 5,845,375 (Miller, et al.), and U.S. Pat. No. 6,076,238 (Arsenault, et al.) and sold by 3M Company (St. Paul, Minn.) as mounting systems under the trade name Dual Lock™ and as diaper closures; and printed hooks like those described in U.S. Pat. No. 5,058,247 (Thomas, et al.) and sold by the Procter & Gamble Company (Cincinnati, Ohio). In general, these male fastener materials all include an array of stems projecting outward from a base sheet, the stems either being bent or varying in cross section along their lengths such that they form “hooks,” “barbs,” or “caps” having engaging surfaces roughly parallel to the surface of the base sheet, the engaging surfaces functioning to engage with the fibers of the mating fabric.

An exemplary second category of male fastener materials are designed to self-engage, i.e., engage with an opposing male fastener of the same or a similar type. Many of these fasteners similarly include protrusions having engaging surfaces roughly parallel to the surface of the base sheet. In many embodiments, the mechanical fastener is a self-engaging fasteners having molded “mushroom” type hooks like those described in U.S. Pat. No. 3,192,589 (Pearson), U.S. Pat. No. 3,270,408 (Nealis), U.S. Pat. No. 3,408,705 (Kayser, et al.), U.S. Pat. No. 5,077,870 (Melbye, et al.), and U.S. Pat. No. 5,212,853 (Kaneko). In one embodiment, the mechanical fastener has molded mushroom and disk shaped hooks and is commercially available from 3M Company, St. Paul under the tradename #854 Scotch® Cubicle Mounting Squares.

In some embodiments, the dry erase sheets described herein can include a release liner (not shown) disposed on the adhesive or adhesive stripes such that the adhesive or adhesive stripe is disposed between the release liner and the dry erase sheet. A release liner disposed on the adhesive or adhesive stripe can help to prevent the adhesive from becoming dirty during transportation of the sheet. Release liners include, for example, silicone coated papers and films, low energy films such a polypropylene and polyethylene, and embossed films such as polypropylene and polyethylene. A release liner may be selected so that has high enough release value to stay adhered to the adhesive before the product is used and low enough to be removed from the adhesive by hand.

Advantages of the invention are illustrated by the following examples. However, the particular materials and amounts thereof recited in these examples, as well as other conditions and details, are to be interpreted to apply broadly in the art and should not be construed to unduly limit the invention.

### EXAMPLES

Writing on Surfaces with Markers

Dry erase surfaces were marked with 14 different markers comprising 7 brands of dry erase markers. The dry erase markers were Avery Marks-A-Lot (Avery-Dennison, Pasadena, Calif.), Boone Screamers (Boone International, Corona, Calif.), Boone Low Odor (Boone International), Dixon Dry Erase (Dixon Ticonderoga Co., Heathrow, Fla.), Expo Bold (Sanford Corp., Bellwood, Ill.), Expo 2 (Sanford Corp.), and Liquid Expo (Sanford Corp.). The markers all had a chisel point. Two colors of marker from each brand were chosen including black if available. It was noted that within the same brand of dry erase marker, some colors were more difficult to remove than others. A typical dry erase sample was about the size of a sheet of paper. For each marker brand a horizontal space about 2.5 cm high on the sample was reserved for that marker brand. The first marker was used to write the marker brand name on the left hand side of the 2.5 cm high space and the second marker was used to write the same marker brand name on the right hand side of the 2.5 cm high space. In this manner, all the writing from each marker brand is lined up in one erasable horizontal line. The name of the marker was written on the film to more easily determine if the marker was completely erased.

Time Aging of Marker Writing

For substrates coated with a radiation curable coating, time aging of the marker writing was accomplished by letting the sample sit for one day at approximately 22 degrees C. (72 degrees F.) in a laboratory environment. For the correctable dry erase substrates, the marker writing was allowed to dry for 3 minutes before further testing. Humidity was not specifically controlled, however, the laboratory was air conditioned.

Marker Wettability Test

After marking the surface of the dry erase article and aging, each marker was examined for evidence of dewetting. Dewetting of the writing was evidenced by the appearance of holes in the writing or a shrinkage of the characteristic writing line. The total number of markers that have evidence of dewetting was calculated. Because there are 14 different markers in the writing test, the range of possible dewetting scores is 0-14. For example, if no markers dewet, the dewetting score is zero. If 10 markers dewet, the dewetting score is 10.

Dry Erase Marker Removal

After writing on the sample and aging for 24 hours, removability of dry erase writing was tested as follows. The sample was placed on a hard, flat surface. An Expo brand dry eraser (Sanford Corp.) was used to erase the writing. The area of the eraser in contact with the sample was about 12.5 cm×5 cm. Steady hand pressure of about 5.2 kgf (8.1 KPa) was maintained on the eraser as it was passed over the first line of marker writing. The first line of writing included the writing from the two markers of the first brand. The number of firm eraser strokes required to remove all but a few specs of marker writing were counted. In many cases a single stroke of the eraser removed all the writing. In other cases it took more than one stroke to remove the writing. The minimum dry erase removal score is 7 because there are a total of 7 lines of dry erase marker writing.

Correctable Marker Test

To test for short term correctability of dry erase markers on a substrate, the same markers were used to write on the surface in the same manner as the Writing on Surfaces with Markers test. The markers were allowed to dry for three minutes. Then an Expo Brand dry eraser was used to remove the writing as in the Dry Erase Marker Removal Test. Up to 10 firm strokes of the eraser were made to attempt to erase the writing using a hand pressure of about 5.2 kgf. The sample passed the correctability test if all of the dry erase markers were completely erased or if the only residual was unreadable smear of the marker. The sample failed the test if any of the markers were readable even as a faint visual ghost image.

Mandrel Bend Test for Flexibility

The mandrel bend test was adapted from ASTM D3111, “Standard Test Method for Flexibility Determination of Hot-Melt Adhesives by Mandrel Bend Test Method”. The test specimens were the uncoated and coated substrates cited in the examples. The specimens were cut into sheets of about 20 by 25 mm. Smaller specimens can also be tested. Each sheet was wrapped 180 degrees around a metal rod or mandrel within 1 second. If the specimen was coated, the coated side of the specimen was on the outside of the mandrel. The mandrel used for this test had a diameter of 6.4 mm (¼ in). The specimen was then removed from the mandrel and examined with a 4× eyepiece or a microscope. Failure of the mandrel bend test was evidenced by the appearance of visible fracture, crazing, or cracking of the substrate.

Release Test

The release test was adapted from ASTM D 6282, “Standard Test Method for Liner Release at 90 Degrees. A ball slide test fixture was placed in the lower jaw of a constant rate of extension (CRE) machine. A layer of double coated 410 tape (3M Company, St. Paul, Minn.) was adhered to the ball slide. A test sample was then adhered to the 410 tape with the side coated with the release layer facing up. The test tape was 3M #810 tape (Scotch Brand Magic Tape) at a 1 inch width. 3M # 810 tape has a permanent adhesive. A length of the tape was placed on the top of the sample. It was then adhered to the sample with a 4.5 lb roller in two passes at ca. 12 in/min per pass. A free end of the tape was attached to the upper jaw of the CRE machine. The upper jaw was moved at a rate of 12 in/min. The CRE machine used in this case gave an average reading of the release force in g/in.

Peel Adhesion Reduction

To measure peel adhesion reduction, the peel adhesion of the 810 tape was measured against a substrate with and without the polymeric release coating by the same method cited in the Release Test above. The peel adhesion value with polymeric release coating is expressed as a percentage of the peel adhesion of the substrate without the polymeric release coating.

Materials

Release coating A was prepared according to Example 39 of U.S. Pat. No. 5,154,962. The release coating was diluted to 2% solids with a 1:1 mixture of isopropanol and toluene.

Release coating B was prepared according to Example 1 of U.S. Pat. No. 3,011,988. The release coating was diluted to 2.5% solids with a 1:1 mixture of isopropanol and toluene. Release coating C was prepared according to Example 2 of U.S. Pat. No. 4,728,571, with the exception that no acrylic acid was added to the reaction mixture. The release coating was diluted to 2% solids with a 1:1 mixture of isopropanol and toluene.

TABLE 1
Compositions of the Release Coatings in Weight Percent

| | Release Coating | Release Coating | Release Coating |
|---|---|---|---|
| Monomer | A | B | C |
| Methyl acrylate | 45 | 11 | |
| N-vinyl | 35 | | |
| pyrollidone | | | |
| Acrylic acid | 5 | 13 | |
| Silicone | 30 | | 30 |
| macromer | | | |
| Octadecyl | | 51 | |
| acrylate | | | |
| Acrylonitrile | | 25 | |
| Isobutyl | | | 70 |
| methacrylate | | | |

### Example 1

The substrate in Example 1 was 1.8 mil clear polyester film available from 3M Company, St. Paul, Minn. The release coating was release coating A at 2% solids. The solution was coated on a laboratory gravure coater using a 250 ruling mill gravure cylinder. The line speed was 25 ft/min and the oven temperature in the 8 foot long oven was 150° F.

### Example 2

The substrate in Example 2 was 2.0 mil clear BOPP (biaxially oriented polypropylene) available from 3M Company, St. Paul, Minn. Release coating A at 2% solids was applied to this substrate by the procedure in Example 1.

### Example 3

The substrate in Example 3 was a correctable dry erase paper obtained from Boise Cascade Corp., Boise, Id. Release coating A at 2% solids was applied to this substrate by the procedure in Example 1.

### Example 4

The substrate in Example 4 was GoWrite dry erase sheets obtained from InVision Enterprises, Palatine, Ill. The dry erase sheets consist of a smooth coated paper that is further coated with a UV curable resin. Release coating A at 2% solids was applied to this substrate by the procedure in Example 1.

### Example 5

The substrate in Example 5 was a 4 mil white polypropylene film available from Rocheux International, Chicago, Ill. The film was coated with a UV curable resin, Gafgard 300, available from ISP Technologies, Wayne, N.J. The Gafgard 300 was diluted to 50% solids with isopropanol. It was coated on a laboratory gravure coater with a 14 BCM volume factor gravure cylinder with a ruling mill pattern. After drying of the solvent, the Gafgard was cured under a nitrogen blanket with a single 300 W/in mercury lamp. The coating speed was 25 feet/min. Release coating A was diluted to 1% solids with a mixture of isopropanol and toluene. It was then applied to this substrate by the procedure in Example 1.

### Example 6

The substrate in Example 6 was a 2.0 mil white dry erase film from Protect-All Corp., Darien, Wis. The dry erase film consists of a white polyester film coated with a UV curable resin. Release coating A at 2% solids was applied to this substrate by the procedure in Example 1.

### Example 7

The substrate in Example 7 was a 2.0 mil white dry erase film from Protect-All, Inc., Darien, Wis. Release coating B was diluted to 2.5% solids with toluene. Release coating B was applied to this substrate on a laboratory coater. This laboratory coater had a knife coating head adapted to coat with a #4 wire wound coating rod. The line speed was 4 feet/min and the oven temperature was 150° F.

### Example 8

The substrate in Example 9 was a 2.0 mil white dry erase film from Protect-All Inc., Darien, Wis. Release coating C was diluted to 2% solids with isopropanol and toluene and then coated on this substrate by the procedure in Example 1.

TABLE 2
Test Results

| | | | | Peel | Peel | |
|---|---|---|---|---|---|---|
| | | | Correct- | adhesion | adhesion | |
| | Markers | Dry | able | No | With | Peel |
| Example | Dewet- | erase | marker | release | release | adhesion |
| # | ting | 1 day | test | coating | coating | reduction |
| Units | Number | Score | Pass/fail | Grams/in | Grams/in | Percent |
| 1 | 0 | nm | Pass | 430.6 | 15.6 | 96.4 |
| 2 | 0 | nm | Pass | 349.0 | 15.8 | 95.2 |
| 3 | 1 | nm | Pass | 273.0 | 43.9 | 83.9 |
| 4 | 0 | 8 | Nm | 232.7 | 27.9 | 87.8 |
| 5 | 3 | 13 | Nm | 150.0 | 16.6 | 88.9 |
| 6 | 0 | 13 | Nm | 354.7 | 14.1 | 96.0 |
| 7 | 0 | 7 | Nm | 354.7 | 69.5 | 80.4 |
| 8 | 0 | 26 | Nm | 354.7 | 10.3 | 97.1 |

Note:
nm = not measured.

The complete disclosure of all patents, patent documents, and publications cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

We claim:

1. A dry erase sheet comprising:
a flexible substrate having a dry erase top surface and an opposing bottom surface;
an adhesive disposed on at least a portion of the bottom surface; and
a polymeric release layer disposed on at least a portion of the dry erase top surface.

2. A dry erase substrate according to claim 1, wherein the flexible substrate comprises a coated paper or film.

3. A dry erase substrate according to claim 1, wherein the dry erase top surface comprises a thermal or radiation curable coating.

4. A dry erase substrate according to claim 1, wherein the adhesive is a repositionable adhesive.

5. A dry erase substrate according to claim 1, wherein the polymeric release layer is 0.01 to 5 micrometers thick.

6. A dry erase substrate according to claim 1, wherein the polymeric release layer is wettable by solvents with surface tension equal to or less than 25 mJ/m².

7. A dry erase substrate according to claim 1, wherein the polymeric release layer reduces a peel adhesion value of the dry erase top surface by 25% or greater.

8. A dry erase substrate according to claim 1, wherein the polymeric release layer provides an adhesive release value of 100 g/in or less to permanent adhesives.

9. A dry erase substrate according to claim 1, wherein the polymeric release layer comprises a polymer formed by co-polymerizing a non-polar monomer and a siloxane monomer.

10. A dry erase substrate according to claim 1, wherein the polymeric release layer comprises a polymer formed by co-polymerizing a polar monomer, a non-polar monomer, and an ester of a (C₁₂-C₂₂) alkyl primary alcohol with acrylic or methacrylic acid.

11. A dry erase substrate according to claim 1, wherein the dry erase sheet comprises a roll of dry erase sheets.

12. A dry erase substrate according to claim 11, wherein the roll of dry erase sheets comprises a roll of individual dry erase sheets having an adhesive stripe along opposing sides of each individual dry erase sheet.

13. A dry erase substrate according to claim 1, wherein the flexible substrate comprises a peripheral edge and one or more frame elements are disposed proximate to the peripheral edge.

14. A dry erase substrate according to claim 1, further comprising a mechanical fastener disposed on the adhesive or bottom surface.

15. A dry erase substrate according to claim 1, further comprising a mechanical fastener having a plurality of male fastener elements disposed on the adhesive or bottom surface.

16. A dry erase substrate according to claim 1, further comprising a release liner disposed on the adhesive.

17. A dry erase pad comprising:
a plurality of flexible substrates having a dry erase top surface and an opposing bottom surface;
each flexible substrate comprising:
an adhesive disposed on at least a portion of the bottom surface; and
a polymeric release layer disposed on at least a portion of the dry erase top surface;
wherein, at least selected top surfaces are in contact with selected bottom surfaces.

18. A dry erase pad according to claim 17, wherein the polymeric release layer is 0.01 to 2 micrometers thick.

19. A dry erase pad according to claim 17, wherein the polymeric release layer is wettable by solvents with a surface tension equal to or less than 25 mJ/m².

20. A dry erase pad according to claim 17, wherein the polymeric release layer reduces a peel adhesion value of the dry erase top surface by 25% or greater.

21. A dry erase pad according to claim 17, wherein the polymeric release layer provides an adhesive release value of 100 g/in or less to permanent adhesives.

22. A dry erase pad according to claim 17, wherein the flexible substrate comprises a peripheral edge and one or more frame elements are disposed proximate to the peripheral edge.

23. A method of making a dry erase substrate comprising steps of:
providing a flexible substrate having a dry erase top surface and an opposing bottom surface;
coating an adhesive on at least a portion of the bottom surface; and
coating an polymeric release layer on at least a portion of the dry erase top surface to form a dry erase substrate.

24. A method according to claim 23, further comprising the step of rolling the flexible substrate into a roll such that the adhesive contacts the polymeric release layer.

25. A method according to claim 23, wherein the step of coating an adhesive comprises stripe coating an adhesive on the bottom surface.

26. A method according to claim 23, wherein the step of coating a polymeric release layer comprises stripe coating a polymeric release layer on the dry erase top surface.

27. A method according to claim 24, further comprising the step of cutting the dry erase substrate into a plurality of sheets and forming a pad of sheets such that the adhesive layer of at least selected sheets contact the polymeric release layer of selected sheets.

28. A method according to claim 23, further comprising the step of disposing a release liner on the adhesive.

29. A method according to claim 23, further comprising the step of disposing a mechanical fastener, having a plurality of male fastener elements, on the adhesive or bottom surface.
